(19) United States
(12) Patent Application Publication
(10) Pub. No.: US 2008/0162158 A1
(43) Pub. Date: Jul. 3, 2008

(54) Authentication Services Compensation System

(76) Inventor: Brian R. Cartmell, Mercer Island, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/618,478

(22) Filed: Dec. 29, 2006

(51) Int. Cl. G06Q 99/00

(52) U.S. Cl. 705/1

(57) ABSTRACT

A system for compensating the provider of authentication services wherein users, in addition to merchants, may be the party who compensates the authentication service provider.

### TECHNICAL FIELD

The technical field of the invention relates generally to authentication services and more specifically to the area of compensation systems for authentication services.

### BACKGROUND ART

In its most general sense, authentication may be defined as a determination that a person (or thing) is a particular person (or thing). In the context of computer systems, authentication is a determination that someone (or thing, in the case of an object or a device such as a computer) is, has, or is capable of reproducing an authentication factor and a corresponding authentication factor value; the authentication factor and/or authentication factor value generally being associated with a particular person (or thing).

Authentication factors may generally be classified according to the following categories: i) Something the user is (e.g., a fingerprint or retinal pattern, a voice pattern, or another biometric identifier or physical attribute); ii) Something the user has (e.g., an identification card or chip, a security token, a phone or email address, etc.); or iii) Something the user knows (e.g., a password, phrase, or PIN).

Authentication factor values are generally produced by and/or associated with an authentication factor. Certain authentication factors may have only one authentication factor value, while other authentication factors may have or produce a range of authentication factor values. In the case of something the user is, authentication factor examples often include physical attributes such as fingerprints, retinal or voice patterns, or other biometric or other physical attributes; in such examples, the authentication factor value is a particular fingerprint, retinal or voice pattern, or the like. In the case of something the user has, an example of an authentication factor is a specialty purpose digital signal processor (“DSP”) which produces a unique number and/or character string or another unique output; the authentication factor value in such an example is a particular instance of the unique number and/or character string output by the DSP. Another example of an authentication factor which falls into the category of something the use has is an access card (the authentication factor) magnetically encoded with a unique identifier (the authentication factor value of the card). In the case of something the user knows, the authentication factor may be a password, phrase, or personal identification number or “PIN,” while the authentication factor value is the specific password, phrase, or PIN known to the user.

The distinctions drawn between these authentication factor categories (is/has/knows) generally assume a human user, though the user (the party or object to be authenticated) may include a physical object, including a computer. A thing, device, or computer can have an electronic, magnetic, structural, or other physical attribute (as well as a particular instance of the physical attribute). A thing, device, or computer can also have a particular thing, such as an ID card or chip, which acts as an authentication factor. A thing, device, or computer can also be said to “know” something such as a password, phrase, or PIN, to the extent the object is programmed or otherwise provided with an embodiment of the “known” information. In the context of things, devices, or computers, however, the placement of authentication factors in the categories, above, depends upon how the concepts of “being,” “having,” and “knowing,” are applied to inanimate objects (does the object “have” a security chip, or is the security chip part of the object the way a fingerprint is part of a person, or does the security chip allow the object to “know” something?). These categories are nonetheless useful in understanding the background art.

It is frequently the case that a given authentication system may require that the user (whether human or otherwise) have more than one authentication factor and more than one authentication factor value from the different categories enumerated above, one or more of which must be successfully communicated (often in a prescribed sequence). For example, a user may have an access card (an authentication factor), which must be properly encoded (an authentication factor value), and which is used in association with a PIN (which, generally, is an authentication factor, while a particular PIN number is an authentication factor value). In another example, a user may have a token (without limitation, such as described in patent application Ser. No. 11/317,568 and the successor continuation-in-part filed on Dec. 15, 2006, with the United States Receiving Office as an International application) as an authentication factor, which token is capable of producing unique numbers and/or character strings or other unique output as authentication factor values.

A term related to authentication is “authorization,” which may be defined as a determination that a known person (or thing, such as a computer) has the authority to perform a particular act, to be in a particular area, to possess an item, or the like. Authorization and authentication are linked, with authentication generally preceding authorization. A person or computer may be authenticated, that is, it may be confirmed that the person or computer is a particular party, but nonetheless not authorized to download a website or access an account of a different party.

Users of various computer and communications systems have become familiar with authentication and authorization systems such which employ authentication factors such as swipe cards and passwords, tokens, login identifiers and passwords, and even signatures (one of the original biometric authentication factors). Most electronic authentication systems have developed as independent systems dedicated to authorizing a person with respect to a particular activity and/or organization, in which case authorization is an implicit part of the authentication process. Such systems authenticate a user for the purpose of accessing an account, car, telephone, files, records, etc.

Multiple independent authentication processes are convenient for merchants and service providers, each of whom may maintain authentication and authorization systems independently from one another without the cost of coordinating the authentication and authorization systems. The existence of multiple authentication processes, however, places a burden on users, who must retain, remember, or otherwise deal with different authentication factors in order to be authorized in different contexts. A person's account login identifier and password for a bank will not generally be the same as a login identifier and password for an email system. It is necessary to remember multiple login identifiers, multiple passwords, to carry a token for one system, a card and a PIN for another. Besides being inconvenient, the result is an overall reduction in security. Users resort to writing down authentication information, passwords are not changed frequently enough, passwords and login identifiers are re-used at multiple merchants and service providers (without systems to prevent misuse), passwords are selected to be easy to remember rather than to be difficult to guess, and systems must be provided to allow account information to be recovered or changed (often through email and/or telephone), all of which reduce overall security.

Third parties have begun to develop authentication services not necessarily tied to a specific authorization process or technology, hereinafter “third party authentication.” See, for example, patent application Ser. No. 11/317,568 and the successor continuation-in-part filed on Dec. 15, 2006, with the United States Receiving Office as an International application, which is incorporated herein in its entirety by this reference, both of which describe third party authentication technologies. If third party authentication services become widespread, burdens on users can be reduced and overall security can be improved.

In an example of third-party authentication, a user in need of authentication obtains a token which is registered with a third party authentication service provider. The token is designed to produce a unique token value which changes over time or according to another parameter. To obtain goods and/or services from a party referred to herein as a “merchant,” (referred to as a “provider” in patent application Ser. No. 11/317,568 and the successor continuation-in-part filed on Dec. 15, 2006) the user obtains a unique token value from the token and communicates it to one or more merchants. Communication of the token value may be transparent to the user, such as through a proximity based system, or it may involve the active participation of the user, such as through typing the token value into a prompt in a user interface. The merchant provides at least the token value and generally another identifier, such as an identifier associated with the user and/or the token, to the third party authentication service provider with whom the user's token is registered. The merchant may also provide other information, such as the time when the token value was supplied. The third party authentication service provider generally confirms (or not) that the token was capable of producing the token value around the time that the token value was provided.

Authentication systems come with real costs which must be paid for. Hardware and network services must be obtained, software and user- and machine-interfaces must be designed, written, and maintained; cards and the like must be manufactured, programmed, and distributed; customer service must support users who loose and/or forget authentication factors; and fraudulent transactions must be investigated and dealt with, often involving expensive legal processes, to list but a few of the costs associated with authentication systems.

Without a third party authentication service, merchants typically absorb the cost of their own authentication-authorization systems as a price of doing business. With a third party authentication service, a common business model is that the third party provider of authentication services charges a fee to the merchant, such as a fee based on a number of users or based on a number of authentication attempts in a particular period of time. If the merchant has a small user base, the third party authentication service provider may also charge the merchant a flat-rate to ensure recovery of sunk costs. Such fees, however, may render the third party authentication service cost-prohibitive.

### BRIEF SUMMARY OF THE INVENTION/DISCLOSURE OF INVENTION

The present invention describes a method and a corresponding computer system to obtain compensation for authentication services by potentially obtaining compensation from someone other than a merchant who is requesting authentication services. In addition to or instead of obtaining compensation from the merchant who is requesting authentication services, the compensating party may be a user or another merchant.

### BRIEF DESCRIPTION OF THE DRAWINGS

FIG. 1 is an exemplary network, device, and actor diagram relating to background of the invention.

FIG. 2 is an exemplary network, device, and actor diagram in and through which systems and methods consistent with the principals of the invention may be implemented.

FIG. 3 is a process flow chart of exemplary steps consistent with the principals of the invention.

FIG. 4 is an exemplary network and device diagram in and through which systems and methods consistent with the principals of the invention may be implemented.

### DETAILED DESCRIPTION/MODE(S) FOR CARRYING OUT THE INVENTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims.

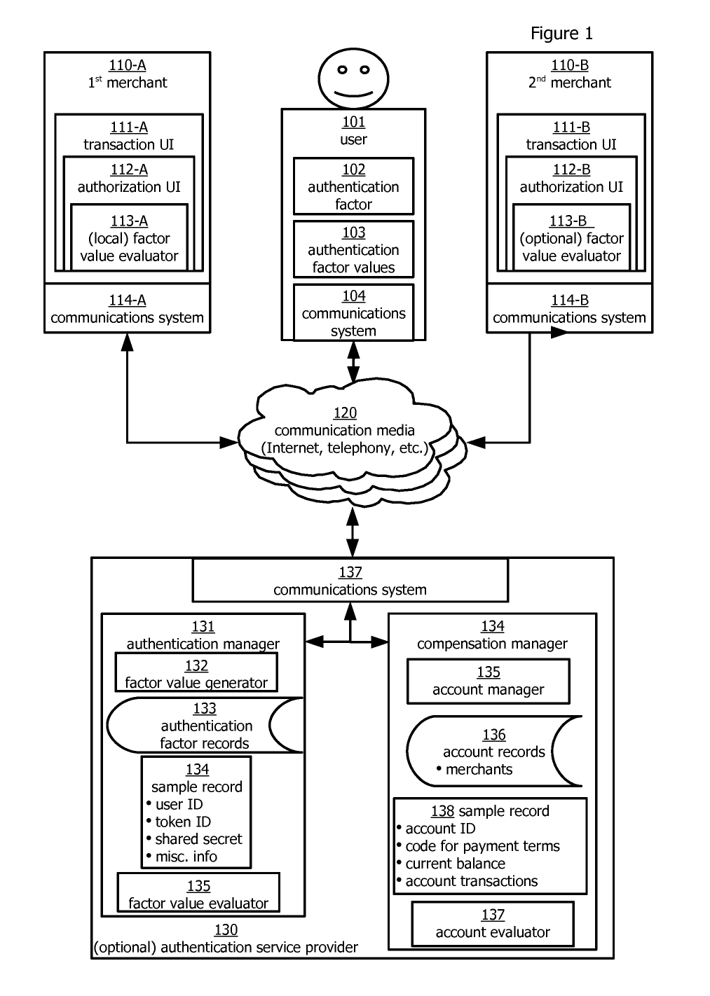

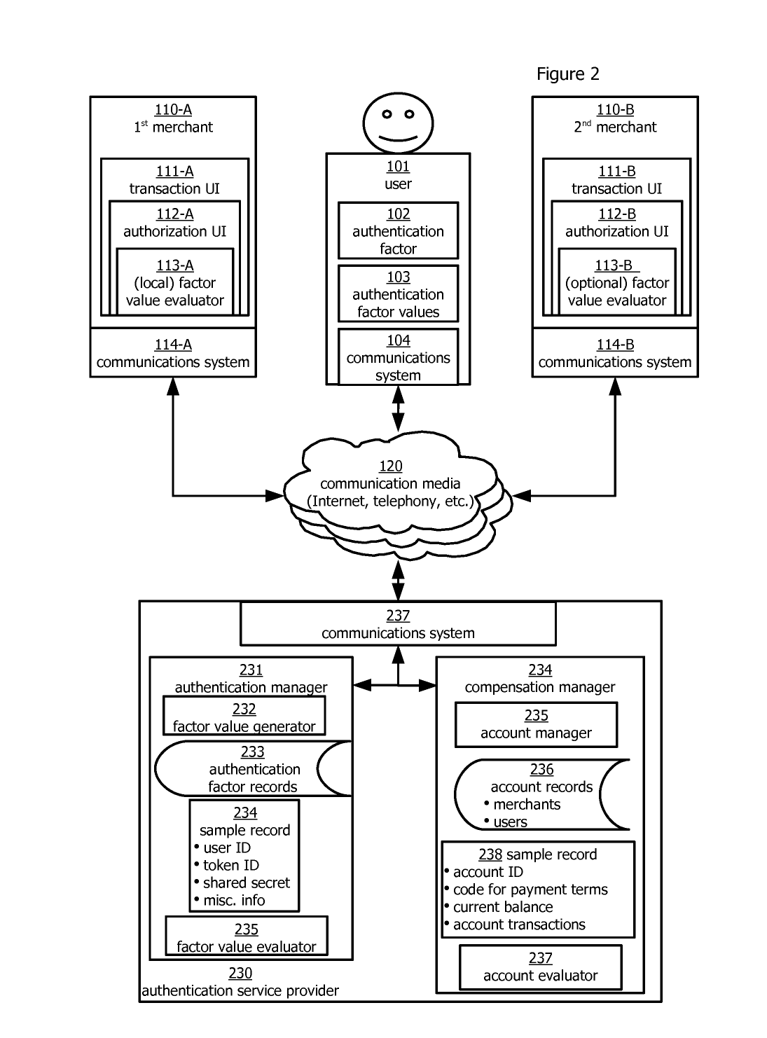

Referring now to FIGS. 1 and 2. Both FIGS. 1 and 2 present a simplified exemplary network, device, and actor diagram; FIG. 1 relates to background of the invention and FIG. 2 relates to the invention described herein. Both FIGS. 1 and 2 depict a user 101. The user 101 may be a person or may be a general or special purpose computer which occupies the role of and/or represents a user 101. The user 101 is engaged in a process of obtaining goods and/or services from at least a first merchant 110-A and potentially other merchants, such as 110-B (additional merchants not shown).

The user 101 possesses or controls at least one authentication factor 102 which is associated with at least one authentication factor value 103. FIGS. 1 and 2 also depict the user 101 as possessing or otherwise controlling a communications system 104. This communications system 104 is largely determined by the physical and logical requirements of merchant's communication system 114-A, the communication media 120 and the authentication factor(s) employed in a given authentication system. For example, the user's communications system 104 may comprise the user's voice or fingers, the communication media 120 may be spoken or gesticulated words, and the merchant's communications system 114-A may comprise the merchant's ears. In a non-exclusive alternative, the user's communications system 104 may comprise a cell phone, the communication media 120 may comprise a cellular telephone network or similar, and the merchant's communications system 114-A may comprise a telephone system. In another non-exclusive alternative, the user's communications system 104 may comprise a computer capable of connecting to the Internet and operating client software such as a browser, the communication media 120 may comprise the Internet, and the merchant's communications system 114-A may comprise a computer capable of connecting to the Internet and operating server software such as a webserver. Practitioners skilled in the art would recognize that these are examples of users and merchants in the context of authentication-authorization systems and should not be understood to limit the invention.

FIGS. 1 and 2 further depict a transaction user interface or “UI” 111-A. The transaction UI 111-A is the interface provided by the merchant to select, order, manage, and pay for the goods and/or services offered by the merchant. Transaction UIs are well understood in the art and may be provided, for example, by a webserver located in the merchant's communications system 114-A which webserver may be configured to serve a website to users with access to browser software which operates as part of the user's communications system 104, as discussed above. As is well known, a transaction UI 111-A may also be provided by a kiosk or automatic teller machine “ATM,” a telephony server and a voice and/or DTMF prompt system, a checkout stand with a swipe-card or RFID card reader station (or similar) or any other system configured to interact with a user 101 and to allow the user to obtain and/or pay for and/or manage goods and/or services provided by the merchant 110-A. As indicated, the transaction UI 111-A may involve manipulation of swipe-cards, tokens, keypads, keyboards, presentation of graphical or auditory information through various conventional audio-visual technologies, and use of the user's communications system 104, the merchant's communication system 114-A, and the communications media 120.

FIGS. 1 and 2 further depict that the transaction UI 111-A includes an authorization UI 112-A. The system apparatus providing the authorization UI 112-A may be physically and/or logically collocated with the transaction UI 111-A or it may be provided remotely, whether by the merchant 110-A (as may be the case when the merchant 110-A provides different components from different locations) or by the (optional) authentication service provider 130 or 230, (the authentication service provider being discussed further below), as is well understood in the art. The authorization UI 112-A refers to those specific steps in a transaction UI 111-A wherein the user's authentication factor values 103 are solicited, received and confirmed (or not) as being associated with a user 101 and, following which authentication, the user 101 is then often also authorized to proceed (or not) with the transaction which the user 101 may be attempting. As depicted, the authorization UI 112-A may include a local authentication factor value evaluator 113-A, likely, though not necessarily, provided by the same party providing the authorization UI 112-A. In the case of practice of the disclosed invention, it is less likely that the merchant 110-A would include a local authentication factor evaluator 113-A, as this function would generally (though not necessarily) be performed by the authentication service provider 230. It should be noted that, in the case of the disclosed invention, it is possible that the authentication service provider 230 could locate computer systems with the systems used by the merchant 110-A and/or with systems used by other service providers who may support the merchant 110-A. For example, and without limitation, the authentication factor value evaluator 235 maintained by the authentication service provider 230 may be distributed, with physical and/or logic processing and/or information bearing components being distributed (generally in an encrypted form) to merchants 110-A and/or to service providers utilized by merchants (not shown) according to a distributed hash table or similar distributed computing technique. In such an instance, the local authentication factor evaluator 113-A may be an instance of or otherwise may be associated with the authentication factor evaluator 235 of the authentication service provider 230.

FIGS. 1 and 2 further disclose an optional authentication service provider 130 in the case of the background art and a (required) authentication service provider 230 in the case of the disclosed invention. As with the other figures, these figures present a simplified and schematic view of the party. In the background art, and as noted previously, authentication services may be performed by the merchant 110-A or may be performed by the (optional) authentication service provider 130. In the case of the disclosed invention and the background art, the authentication service provider 130 and/or 230 may be provided from a remote physical and/or logical location relative to the merchant 110-A or the authentication service provider 130 and/or 230 may be provided by physically and/or logically co-locating computer and other electronic systems (which may be embodied in software and/or in hardware) and/or human representatives of the authentication service provider 130 and/or 230 with the merchant(s) 110-A and the merchant's transaction UI 111-A, authorization UI 112-A, and (local) factor value evaluator 113-A, as discussed above. Computer equipment supporting the activities of the authentication service provider 130 or 230 may be provided by one or more conventional commodity general purpose computers operating well understood software applications, such as operating systems, webservers, telephony servers and the like, which must be provided with access to a communication system 137 or 237 which is capable of interfacing with the various communication media 120 utilized by the merchants 110-A and users 101.

The authentication service provider 130 or 230 is depicted as including an authentication manager 131 or 231 and a compensation manager 134 or 234. While graphically depicted as separate objects, these components represent different functional activities which may be physically and/or logically collocated within the same computer or set of networked computers and which may be provided by a shared set of common software applications.

The authentication manager 131 or 231 is shown to include an authentication factor value generator 132 or 232, authentication factor records 133 or 233, a sample authentication factor record 134 or 234, and an authentication factor value evaluator 135 or 235. As is understood in the art, these components may be used in conjunction to evaluate authentication factor values 103 provided by users 101 and/or merchants 110-A. For example and without limitation, a user 101 may have a token which acts as an authentication factor 102. The token provides an authentication factor value 103 to the user 101 and/or to a merchant 110-A, through the transaction UI 111-A and the authorization UI 112-A. The merchant 110-A may pass the authentication factor value 103 to the authentication service provider 137 or 237 via the merchant's communications system 114-A, the communication media 120, and the authentication service provider's communication system 137 or 237, such as through an http interaction over an encrypted secure sockets layer (“SSL”), also called an “https” connection. The authentication service provider 130 or 230 decrypts and parses the communication containing the authentication factor value 103, which in this example would likely also contain a token or user ID, an identifier for the merchant 110-A, and other information, such as the time at which the authentication factor value 103 was provided. An authentication factor value evaluator 135 or 235 may then access the authentication factor records 133 or 233 to obtain the shared secret, such as an encryption key, which corresponds to the user and/or token ID and which should have been utilized by the user's token to produce the authentication factor value 103. The shared secret and the other information, such as the time information, may be utilized by an authentication factor generator 132 to attempt to reproduce the previously provided authentication factor value 103. If a match is obtained, the authentication service provider 130 or 230 returns a corresponding message to the merchant 110-A.

As noted above, the authentication service provider 130 or 230 is also depicted as including a compensation manager 134 or 234. The compensation manager 134 or 234 is depicted as including components for an account evaluator 137 or 237, an account manager 135 or 235 and account records 136 or 236. While graphically depicted as separate objects, these components represent different functional activities that may be physically and/or logically collocated within the same computer or set of networked computers and which may be provided by a shared set of common software applications. The account evaluator may, at any point during a request to authenticate an authentication factor value, access account records 136 or 236 to determine if the party requesting the authentication services has an account (or equivalent) with the authentication service provider 130 or 230, whether or not the account is current, and, in the case of the present invention, whether a user account provides that the user may be the party who compensates the authentication service provider 230. The account manager 135 or 235 may access the account records 136 or 236 to debit or credit accounts and to record other transactions and account activities.

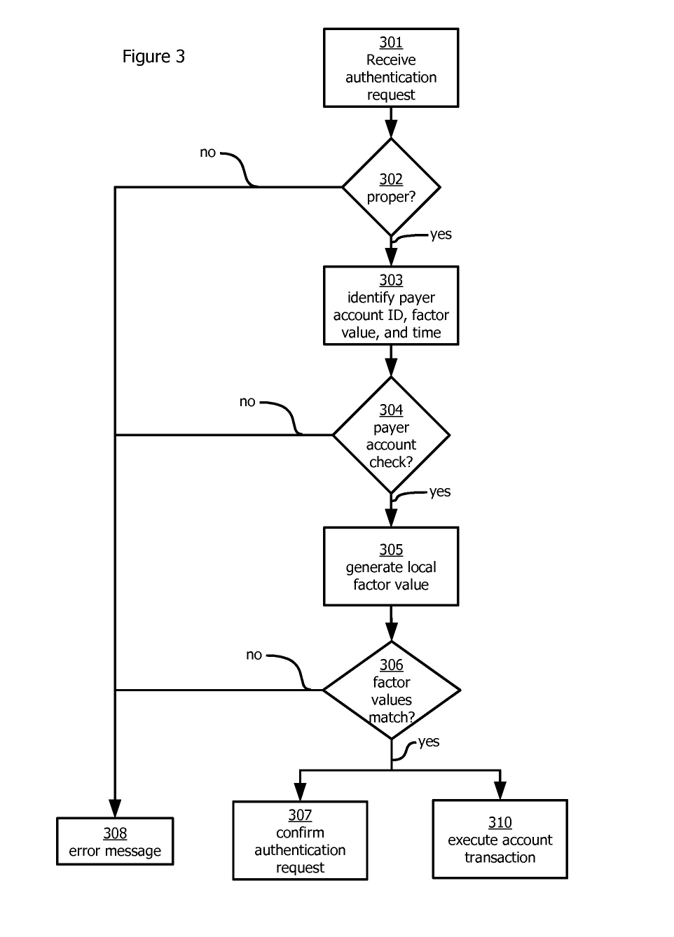

In the case of the background art, accounts reflected in the account records 136 may be created as a result of contracts entered into between the authentication service provider 130 and the merchants 110-A and 110-B. In the case of the disclosed invention, and as is noted in FIG. 236, account records 236 may also be created as a result of contracts entered into between the authentication service provider 230 and users 101. Creation of an account in either context would generally be recorded through the creation of an account record, such as the sample account record 138 or 238. In the case of the background art, such contracts (with merchants 110-A) would generally be negotiated and executed in advance. In the case of the present invention, the contracts may further be of a click-thru or similar variety wherein any party desiring to present a request for authentication services may, prior to and/or contemporaneous with submitting the request, agree to terms established by the authentication service provider 230, thereby creating a new account and an account record such as the sample account record 238. Such a request may, for example, originate with a merchant 110-A who has never presented an authentication service request before. In the case of the presently disclosed invention, and as is discussed in greater detail, below, with respect to FIG. 3, such a request may be honored if the request is able to identify a party (which may include the requesting party, a third party, or a user) who has agreed that the authentication service provider 230 may charge a fee or otherwise debit an account associated with such identified party.

The sample account record 138 or 238 is depicted as including fields such as an account identifier or ID, a code (or similar) to indicate the payment terms between the account holder and the authentication service provider 130 or 230 (which may include payment terms requiring pre-payment, pay-as-you go, and/or some form of credit), a current balance (which may also reflect the availability of credit), and fields for account transactions, such as specific credits or debits or other transactions. Those skilled in the art would readily appreciate that this is a example of an record pertinent to this disclosure, that such records may likely include much more information which is not necessarily relevant to this disclosure, and that, as such, this recitation and the figures should not be understood to limit the disclosed invention.

FIG. 3 depicts a process flow chart with respect to the disclosed invention wherein an authentication service provider 230 receives an authentication request 301. After likely decrypting and parsing the received authentication service request (not shown), the authentication service provider 230 would generally first determine if the request is proper 302, such as whether the request is formatted correctly, whether entries within the request fall within allowed ranges, and similar. If the request is determined to be proper, the authentication service provider 230 may in step 303 then identify the party responsible for compensating the authentication service provider 230 (the “payer”)—which generally will be accomplished by identifying an account ID in the received authentication request—as well as the authentication factor value and other information, such as the time and a user and/or token ID, which may be contained in or be part of the received authentication request 301. This step need not be performed in this specific order, but could be performed at any time. If a user 101 is the payer, the account identifier may be provided by or by reference to a token ID or a user ID, in which case it may not be necessary to include a separate account ID in the authentication request. In the case of the disclosed invention, and in contrast to the background art, the payer may be a user 101 or a merchant 110-A or 110-B.

FIG. 3 depicts another decision point wherein the payer's account is checked 304 to determine if the payer has a current account, whether the payer's balance (including available credit) is positive, and whether the terms of the relationship with the payer provide that the authentication service request may be processed. For example, the authentication service request may be from a party, possibly a merchant 110-A, who does not have an account with the authentication service provider 230, but the authentication request identifies a party who does have an account with the authentication service provider 230, which identified party may be a user 101 or another party, such as a merchant 110-B. Such identified party may have an entry in an account record which corresponds to such identified party, such as the example account record 238, which provides a code or other indication of the payment terms between such identified party and the authentication service provider 230. Such code or other indication of the payments terms may provide that such identified party will compensate the authentication service provider 230, notwithstanding that the request for authentication services may not have originated from such identified party. Notwithstanding the presence of a code indicating a willing payer, other entries in the account record for the identified party may result in an adverse decision at the step of checking the payer's account 304, such as, for example and without limitation, that the identified party does not then have a positive balance (including remaining credit), or that the identified party's account is locked due to suspected fraudulent activity or for another reason.

As is illustrated by the foregoing examples, resolution of decision point 304 would generally turn on evaluation of the entries in the specific record, such as the example account record 238, which corresponds to the account identifier. As with step 303, this step may be performed in a different order than that depicted in FIG. 3. Such evaluation may be performed by the account evaluator 237, depicted in FIG. 2.

Provided that the outcome of step 304 is affirmative (that is, that a payer has been identified, that the terms of the relationship between the payer and the authentication service provider are such that the authentication service provider may proceed, and that the payer has a sufficient account balance (including credit) to provide the authentication service provider with reasonable assurance of being compensated) FIG. 3 then depicts generating a local authentication factor value 305 (“local” relative to the authentication service provider 230). The local authentication factor value would be generated by obtaining the token and/or user ID from the authentication service request (from step 303), using this to access the appropriate account record, such as the sample record 234, looking up therein the shared secret—such as an encryption algorithm—which should have been used to produce the received authentication factor value, providing the shared secret and potentially other information received in the authentication service request, such as the then-current time, to the authentication factor value generator 232, and then generating a local authentication factor value 305.

Following this step, FIG. 3 then depicts another decision point, 306, wherein the received authentication factor value and the local authentication factor value 305 are compared, likely by the authentication factor value evaluator 235, to determine if they match. Provided that the outcome of step 306 is affirmative (that is, that the authentication factor value may have been produced by the authentication factor at approximately the time it was provided), the authentication service provider 230 may then confirm the authentication service request 307 and may execute an account transaction 310 corresponding to the payment terms. For example, the account manager 235 may be utilized to debit the payer's account, to note the occurrence of the authentication factor evaluation at step 306, to note the inputs to and outcome of step 306, to note the party, if one is identifiable, who submitted the authentication service request at step 301, to note the time at which such events took place, and the like.

If any of the decision points in FIG. 3 are negative, the authentication service provider may return an error message 308. The error message 308 may be customized to the circumstances which produced the negative result at the relevant decision point, or it may be a generic error message. The authentication service provider may also provide that providing no response shall be understood to constitute an error message.

The receipt and processing of the authentication service request 301 is depicted in FIG. 3 as being a linear process involving only a first external input (the receipt of the authentication service request 301). It would be understood in the art that the authentication service request 301 and the processing of it according to the steps in FIG. 3 may be broken into multiple discrete steps and involve iterative communication with the party who lodges an authentication service request. For example, a confirmation may or may not be returned that the request was properly formed at step 302, that the payer account check was positive or negative, and that the authentication factor value was evaluated as true or false. Further by way of example, communication of the payer's account identifier, authentication factor value, time and other information may take place in separate steps, rather than in one step. The communication between the parties may be connection oriented (stateful) or connectionless (stateless).

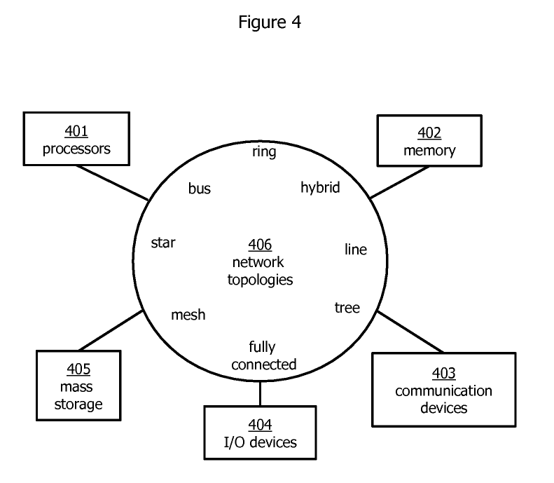

As noted above, an embodiment of the invention in a computer system may be implemented in commodity personal computers, utilizing software (including an operating system and application software, such as a webserver and a database application) and supported by hardware and communication systems as are well known in the art. An exemplary diagram of the components of such a computer system and potential network architectures to allow communication between such components is depicted in FIG. 4.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

### INDUSTRIAL APPLICABILITY

The disclosed invention has applicability to the authentication services industry.

What is claimed is:

1. A method for compensating an authentication service provider, comprising the following steps, not necessarily in the following order:
receiving at least one authentication service request;
contractually obligating at least one party to compensate at least one authentication service provider in exchange for authentication services, which at least one obligated party comprises merchants and/or users;
obtaining compensation from at least one of the at least one obligated parties.

2. The method according to claim 1 where the compensation is a charge associated with the at least one authentication service request.

3. The method according to claim 1 where the compensation is a flat-rate associated with a number of authentication service requests and/or with providing authentication services for a period of time.

4. The method according to claim 1, where the obligated party further comprises a third party.

5. The method according to claim 1, where a merchant submits at least one of the at least one authentication service request and where the compensation is obtained from a party other than the submitting merchant.

6. The method according to claim 1, further comprising determining if a party identified as an obligated party in the at least one authentication service request is in fact an obligated party with a valid account.

7. The method according to claim 6, further comprising declining to or continuing to process the at least one authentication service request if an obligated party in fact with a valid account has not or has been identified, respectively.

8. The method according to claim 1, further comprising authenticating an authentication factor and/or an authentication factor value associated with the at least one authentication service request.

9. The method according to claim 1, further comprising returning a message to at least the party who submitted the at least one authentication service request.

10. The method according to claim 8, where the message comprises the result of evaluating the authentication service request.

11. A computer system to compensate an authentication service provider for authentication services, comprising the following components:
a first data structure in which to store user and/or merchant account information;
computer implemented instructions which, when implemented, note compensation paid or to be paid in relation to a user and/or a merchant account;
computer implemented instructions which, when implemented, authenticate an authentication factor and/or an authentication factor value;
at least one computer processor suitable to execute instructions;
a first communication system which provides communication between the first data structure and the at least one computer processor;
a second communication system which provides communication between at least one of a merchant and/or a user and the at least one computer processor.

12. The computer system according to claim 11 further comprising computer implemented instructions which provide an interface through which a party may identify a user and/or a merchant account which may be debited in association with a request to authenticate an authentication factor and/or an authentication factor value.

13. The computer system according to claim 12 wherein the interface comprises an application program interface.

14. The computer system according to claim 11 further comprising computer implemented instructions which determine if an account has a then-present status which allows continued processing of a request to authenticate an authentication factor value.

15. The computer system according to claim 11 further comprising computer implemented instructions which, when implemented, provide an interface through which a party may enter into a contractual relationship with an authentication service provider.

16. The computer system according to claim 15 where the contractual relationship provides that a party other than one who submits an authentication factor value for authentication may compensate the authentication service provider.

17. The computer implemented instructions which, when implemented, note compensation paid or to be paid in relation to a user and/or a merchant account according to claim 11, further comprising instructions to note compensation paid or to be paid relative to a user account as a result of the processing of a request for authentication services submitted by a merchant.

18. A computer-readable medium encoded with computer-executable components that compensate an authentication service provider, the computer-executable components comprising:
a first data structure in which to store user and/or merchant accounts;
an authentication manager configured to authenticate authentication factors and/or authentication factor values; and
a compensation manager configured to note compensation from at least one of users and/or merchants.

19. The computer-readable medium encoded with computer-executable components according to claim 18 wherein the compensation manager notes compensation from a user as a result of processing an authentication service request from a merchant.

20. The computer-readable medium encoded with computer-executable components according to claim 18 wherein the authentication manager is configured such that it will not return the result of an authentication service request if the compensation manager is unable to identify a user and/or a merchant who has agreed to compensate the authentication service provider.
